(19) United States
(12) Patent Application Publication
(10) Pub. No.: US 2004/0264702 A1
(43) Pub. Date: Dec. 30, 2004

(54) Method and apparatus for producing cryptographic keys

(76) Inventor: Donald E. Eastlake III, Milford, MA (US)

Correspondence Address: MOTOROLA, INC., 1303 EAST ALGONQUIN ROAD, IL01/3RD, SCHAUMBURG, IL, 60196

(21) Appl. No.: 10/610,403

(22) Filed: Jun. 30, 2003

(51) Int. Cl. H04L 9/00

(52) U.S. Cl. 380/277

(57) ABSTRACT

A method and apparatus for producing a cryptographic key is provided herein. In accordance with the preferred embodiment of the present invention information is embedded within the cryptographic key so that there exists no way to remove the information from the key and have the key function. Since the cryptographic key is generated comprising information embedded within the key, one will be able to determine information about the key simply by analyzing the key itself.

### FIELD OF THE INVENTION

The present invention relates generally to cryptography and in particular, to a method and apparatus for producing cryptographic keys.

### BACKGROUND OF THE INVENTION

Early public key systems and many current keying systems are based on certificates. Certificates are objects that contain a public key along with date, identity, and/or authorization information bound together and signed by some “authority.” In order for a public key system to be secure, every different principal must have a different public/private key pair so the public keys for different principals must be distinct. This has lead to systems in which these unique public key values are themselves used as identification tokens. Examples of systems that use or can use a bare public key as a token are SPKI (Simple Public Key Infrastructure), SSH (Secure Shell), MOSS (MIME Object Security Services), and essentially any system where the authenticity of a public key can derive from its manual entry rather than from a certificate.

Even where a key is initially accompanied by additional information, processing may result in the bare key appearing in some contexts or being transmitted to some processing elements. In some systems of limited scope, information associated with a public or other key can be recovered by looking up the key in a specific directory. However, in the general case, with just a bare key, one has no idea what directory to look in or how else to determine identification or authorization information associated with that key. Therefore a need exists for a method and apparatus for producing cryptographic keys that incorporate identity, authority, or date information, or any combination of these within the key. This eliminates the need for embedding the key within a certificate or alternatively finding the key in a directory.

### BRIEF DESCRIPTION OF THE DRAWINGS

FIG. 1 is a block diagram of a storage device utilized for storing cryptographic keys.

FIG. 2 is a flow chart showing cryptographic key generation in accordance with the preferred embodiment of the present invention.

FIG. 3 illustrates the generation of a RSA cryptographic key modulus in accordance with the preferred embodiment of the present invention.

FIG. 4 is a flow chart showing the steps needed to retrieve information from a cryptographic key.

FIG. 5 is a flow chart showing decryption/verifying in accordance with the preferred embodiment of the present invention.

FIG. 6 is a flow chart showing encryption in accordance with the preferred embodiment of the present invention.

FIG. 7 is a flow chart showing key agreement in accordance with the preferred embodiment of the present invention.

### DETAILED DESCRIPTION OF THE DRAWINGS

To address the above-mentioned need, a method and apparatus for producing a cryptographic key is provided herein. In accordance with the preferred embodiment of the present invention information is embedded within the cryptographic key so that there exists no way to remove the information from the key and have the key function. Since the cryptographic key is generated comprising information embedded within the key, one will be able to determine information about the key simply by analyzing the key itself.

The present invention encompasses a method for producing a cryptographic key. The method comprising the steps of determining information that is to be embedded within the cryptographic key, and embedding the information within the cryptographic key.

The present invention encompasses a method for retrieving information about a cryptographic key. The method comprises the steps of determining that information needs to be retrieved from the cryptographic key, determining a number (N) of bytes of information existing within the cryptographic key, and analyzing the N bytes of the cryptographic key to determine the information.

The present invention encompasses a method for decrypting/verifying data. The method comprises the steps of receiving encrypted/signed information, determining a cryptographic key, and utilizing the cryptographic key for decrypting/verifying the encrypted/signed information, wherein the cryptographic key contains information embedded within the cryptographic key.

The present invention encompasses a method for encrypting/signing information. The method comprising the steps of accessing information, determining a cryptographic key, wherein the cryptographic key comprises information embedded within the cryptographic key, and encrypting/signing the information with an encryption/signature algorithm that utilizes the cryptographic key.

The present invention encompasses a cryptographic key comprising information embedded within the cryptographic key.

The present invention encompasses an apparatus comprising means for determining information that is to be embedded within the cryptographic key and means for embedding the information within the cryptographic key.

The present invention encompasses an apparatus comprising means for determining that information needs to be retrieved from a cryptographic key, means for determining a number (N) of bytes of information existing within the cryptographic key, and means for analyzing the N bytes of the cryptographic key to determine the information.

The present invention encompasses an apparatus comprising means for receiving encrypted/signed information, means for determining a cryptographic key, and means for utilizing the cryptographic key for decrypting/verifying the encrypted information, wherein the cryptographic key contains information embedded within the cryptographic key.

The present invention encompasses an apparatus comprising means for accessing information, means for determining a cryptographic key, wherein the cryptographic key comprises information embedded within the cryptographic key, and means for encrypting/signing the information with an encryption/signature algorithm that utilizes the cryptographic key.

The present invention encompasses a method for agreeing on a key for communication with another party. The method comprises the steps of receiving cryptographic key agreement key from another party, determining a local cryptographic key, and utilizing the cryptographic keys for key agreement, wherein either or both of the cryptographic keys contains embedded information.

The present invention encompasses an apparatus comprising means for receiving a cryptographic key agreement key from a remote party, means for determining a local cryptographic key, and means for utilizing the cryptographic keys for agreeing on a key to use in communication, wherein the remote or local cryptographic keys or both of them contain embedded information.

The present invention encompasses an apparatus comprising means for accessing information, means for determining a cryptographic key, wherein the cryptographic key comprises information embedded within the cryptographic key, and means for agreeing on a key with a remote party through a key agreement algorithm that utilizes the cryptographic key.

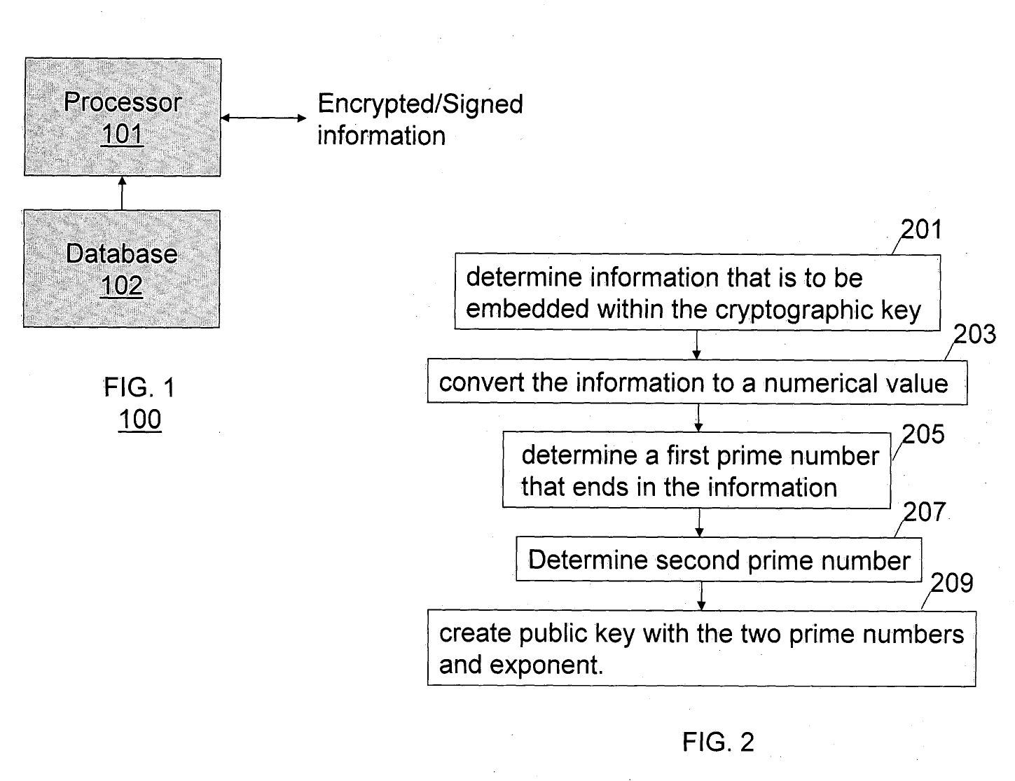

Turning now to the drawings, wherein like numerals designate like components, FIG. 1 is a block diagram of device 100 utilized for encrypting data, decrypting data, signing data, verifying signatures, key agreement, and/or generating cryptographic keys in accordance with the preferred embodiment of the present invention. As shown, device 100 comprises processor 101 utilized for encoding/decoding encrypted information and/or generating cryptographic keys. Device 100 additionally comprises database 102 utilized for storing cryptographic keys and/or encrypted/decrypted data. Processor 101 may be any microprocessor/controller such as, but not limited to a Motorola PowerPC processor, Motorola PowerQUICC, Intel Pentium, . . . , etc. Database 102 may comprise any form of permanent or temporary storage such as, but not limited to Random Access Memory (RAM), Read Only Memory (ROM), hard-disk memory, . . . , etc.

As one of ordinary skill in the art will recognize, various algorithms exists for encrypting/decrypting data, signing/verifying data, key agreement, and generating cryptographic keys. Such algorithms include, but are not limited to the RSA (Rivest-Shamir-Adelman) signature/encryption/decryption algorithm, the AES (Advanced Encryption Standard) encryption/decryption algorithm, and the Diffie-Hellman key agreement algorithm. These algorithms typically comprise some sort of public key and private key pair or a secret key that is needed in order to perform the algorithm on the data. For example, in a system utilizing an RSA-type algorithm, a public key is defined that contains a “modulus”, that is the product of two prime numbers P and Q and an exponent. Data is then encoded with the public key. The RSA algorithm is designed in such a way that to decipher (decode) the message the recipient must have knowledge of the modulus and of a different exponent. It is computationally infeasible to derive either exponent from the other without knowledge of P and Q and the difficulty of factoring the product of two large primes numbers, such as P and Q, is the strength of the RSA algorithm.

During decryption/verification, encrypted/signed data enters processor 101. Processor 101 accesses database 102 to determine a key, and then decrypts/verifies the encrypted/signed data utilizing a standard decryption/verification algorithm. In a similar manner, during encryption/signing processor 101 accesses data within database 102 and applies an encryption/signature algorithm to encrypt/sign the data. As discussed above, cryptographic keys are necessary to properly encrypt, decrypt, sign, or verify data. In the preferred embodiment of the present invention processor 101 may generate all cryptographic keys necessary for encrypting or decrypting the data.

As discussed above, there exist many situations where cryptographic keys exist without accompanying identifying information. Thus, a user may want to encrypt/decrypt/sign/verify information or agree on a shared secret key with another party, but may not know which cryptographic key to utilize. In order to address this issue, in the preferred embodiment of the present invention, bare cryptographic keys are made self-identifying and additionally made to carry other information by the inclusion of information within the key itself. In other words, instead of having information accompany a cryptographic key, (for example, having a key exist within a certificate), the cryptographic key itself contains this information, with no way to eliminate or change the information and have the system work at all.

For example, consider a standard RSA public key. Such keys are generally very large, and consist of a large modulus and a variable length exponent. The modulus is usually at least 1024 bits long and frequently 2K or 4K bits, for example, so the loss of a few dozen bytes for identification need not be a major security concern. If necessary, the key can be made longer to maintain security despite the fixing of some bits in the key for identification purposes. Different algorithms will require different techniques for fixing bits for identification purposes. In addition, because randomness is reduced, they will lose different amounts of strength. However, in general, if N bytes are being fixed to transmit identification information, a minimum of N bytes of strength will be lost.

For RSA keys fixing some modulus bits can be accomplished as follows: Since an RSA key modulus is the product of two primes, to fix the bottom N bytes of their product, the bottom N bytes of one prime are required to have a predetermined pattern, namely, N−1 bytes of 0x00 followed by a 0x01 byte. In addition, identification information is placed within the second prime number such that the bottom N bytes of the second prime number contain the identification information. By choosing the first and the second prime numbers this way and to each be 2*N bytes long or larger, the bottom N bytes of the product is fixed to be the identification information. This reduces the strength of the resulting modulus by 2*N bytes. Since the desired N bytes must have their lowest order bit a one, in the preferred embodiment of the present invention an encoding scheme is utilized where a lowest order byte is appended to the desired sequence.

As an example, consider the case where information (e.g., an internet address, a physical address, a company's name, any textual information comprising words, wording, . . . , etc.) is stored in the least significant bytes of an RSA public key modulus. To assure a lowest order bit of one, information will be appended to the information as a byte consisting of the length (L) of the information, left shifted one plus one ((L<<1)+1). If the information comprises, for example, an Internet address utilizing the “http:” scheme, the information can reference a typed object such as a VCARD with multiple information fields or a MIME multipart. Assuming the information to be embedded is “http://foo.example”, this can be accomplished at the cost of 38 bytes, or 304 bits of strength, as follows:

The desired public key modulus will end with “http://foo.exampleX” where X is a byte containing the length of 18 decimal (0x12) left shifted by one and with the least significant bit on (0x25), in other words 0x687474703A 2F2F666F6F 2E6578616D 706C6525. In the preferred embodiment of the present invention the least significant nineteen bytes of one of the two modulus prime factors is fixed to this value and the least significant nineteen bytes of the other is fixed to eighteen zero bytes (0x00) followed by 0x01. The upper bytes of each initial candidate for the prime modulus factors would be formed by prefixing these values with cryptographically strong randomness (except that the most significant bit is a one). The prime search from each initial candidate would be done by incrementing each by 2**(19*8). The resulting public key comprises the product of two prime numbers having address information embedded therein and the public exponent.

FIG. 2 is a flow chart showing cryptographic key generation in accordance with the preferred embodiment of the present invention. The logic flow begins at step 201 where processor 101 determines information that is to be embedded within the cryptographic key. As discussed above, such information may include, but is not limited to an internet address, a physical address, a company name, a specification of the key holder's authority, a date, . . . , etc, or a combination of these. Once determined, at step 203 processor 101 converts the information to a numerical value. For example, in the preferred embodiment of the present invention each letter is replaced by its numerical ASCII equivalent, in binary form. Processor 101 then determines a first prime number that ends in the information (i.e., a prime number ending in the numerical ASCII equivalent of the information) (step 205). It should be noted that the numerical equivalent of the information may end in an even number (e.g., 2), and hence cannot be prime. Therefore, to assure a lowest order bit of one, a value, X, having a lowest order bit of one is appended to the binary form of the information.

Continuing, at step 207 a second prime number is determined by processor 101. As discussed above, if the numerical equivalent of the information plus the value X is N bytes long, then the second prime number is chosen so that the second prime number comprises N−1 bytes of 0x00followed by a 0x01 byte. As discussed above, by choosing two prime numbers as such, their product is assured to end with the ASCII equivalent shifted by X. Finally, at step 209 a public key is created with the two prime numbers and by determining an exponent.

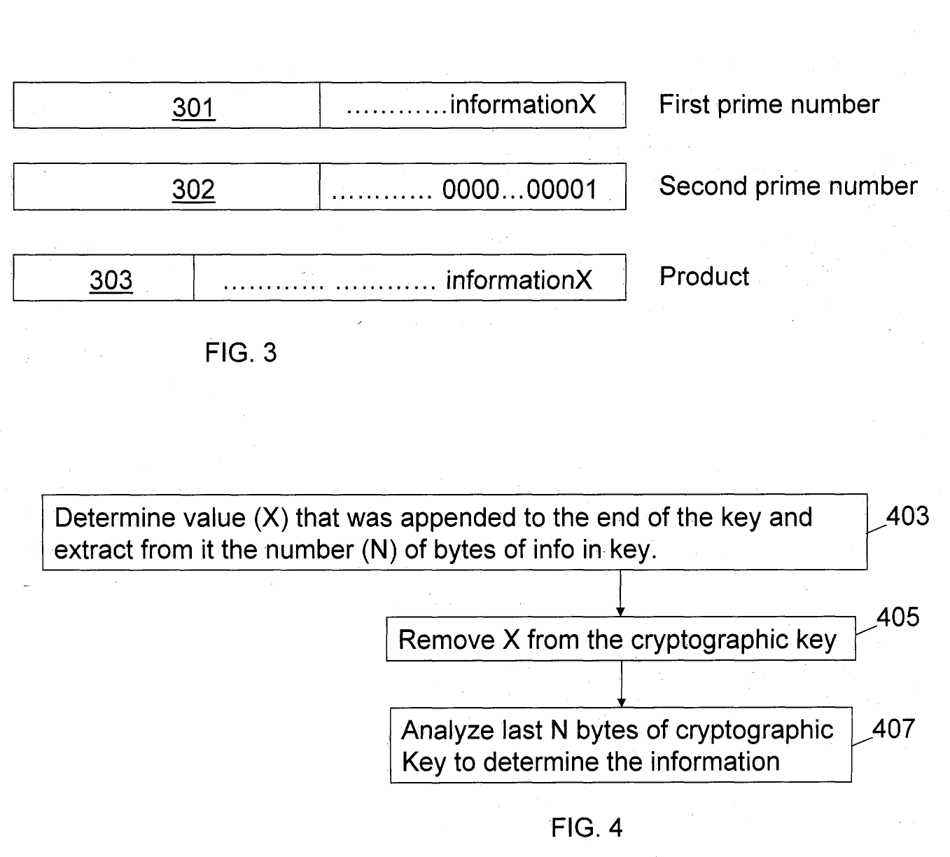

FIG. 3 illustrates the generation of a RSA cryptographic key modulus in accordance with the preferred embodiment of the present invention. As shown first prime number 301 comprises a prime number ending with information shifted by a value X. Second prime number 302 ends with N−1 bytes of 0x00followed by a 0x01 byte. Finally, the product of the first and the second prime numbers ends with the information with a value X appended.

Since the cryptographic key generated above comprises information embedded within the key, one will be able to determine information about the key simply by analyzing the key itself. For example, assume a key from a trusted source is to be used to communicate with a remote party. This key might have been manually entered or have been received in a signed message. Through the use of this invention, the identity of the remote party could be determined directly from the key by any and all pieces of software that handle the key, regardless of what identity information, if any, accompanied the key in data outside the key.

As discussed above, in the preferred embodiment, to determine information existing within the cryptographic key, one simply needs to analyze the least significant bits of the modulus to obtain this information. More particularly, once it is determined that information needs to be retrieved from the cryptographic key, the steps needed to retrieve information from the cryptographic key are described below with reference to FIG. 4. The logic flow begins at step 403 where processor 101 serves as means for determining a number (N) of bytes of information existing within the cryptographic key. In the preferred embodiment of the present invention the number N is obtained from the upper seven bits, treated as a binary number, of the bottom byte “X” of the key. At step 403 processor 101 determines a value (X) that was appended to the end of the N bytes of information. As with N, this information is known beforehand. At step 405, processor 101 removes X from the cryptographic key, and the last N bytes are analyzed by processor 101 to determine the information (step 407).

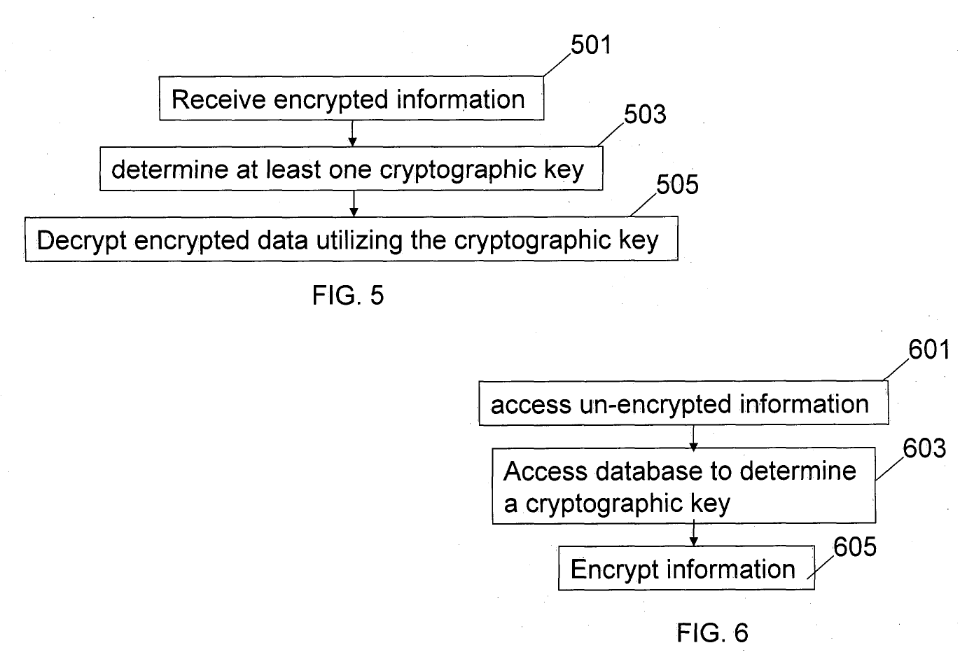

FIG. 5 is a flow chart showing decryption/verifying in accordance with the preferred embodiment of the present invention. The logic flow begins at step 501 where encrypted or signed information is received at processor 101. Processor 101 then accesses database 102 to determine at least one cryptographic key utilized for decrypting the data. As discussed above, in the preferred embodiment of the present invention the cryptographic key contains information embedded within the key. Finally, at step 503 the encrypted/signed data is decrypted/verified by processor 101 utilizing the cryptographic key containing the information embedded within the key.

FIG. 6 is a flow chart showing encryption in accordance with the preferred embodiment of the present invention. The logic flow begins at step 601 where processor 101 accesses un-encrypted information. At step 603 processor 101 accesses database 102 to determine a cryptographic key utilized for encrypting data. As discussed above, the cryptographic key comprises information embedded within the key. Finally at step 605 the information is encrypted by processor 101 utilizing the cryptographic key.

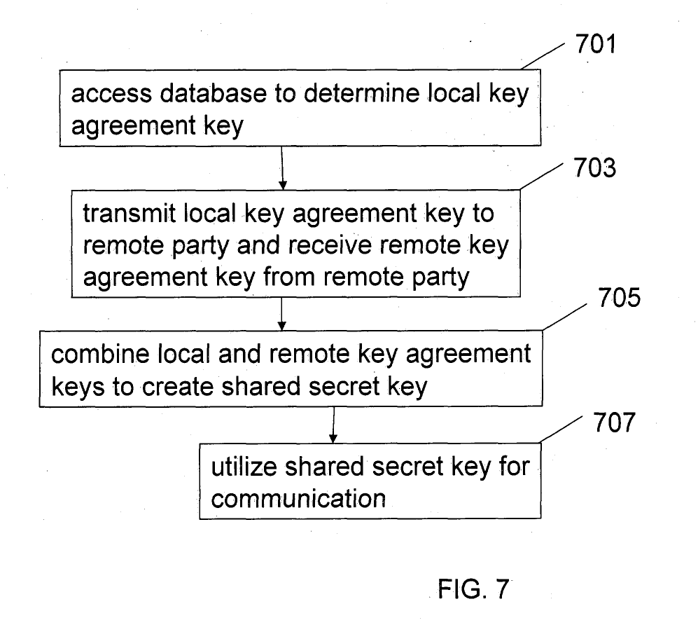

FIG. 7 is a flow chart showing key agreement in accordance with the preferred embodiment of the present invention. The logic flow begins at step 701 where processor 101 accesses its key agreement key from database 102. Processor 101 then, in step 703, transmits its key agreement to the party with which it wishes to securely communicate and received that party's key agreement key. In step 705, it uses a key agreement algorithm appropriate to the key agreement keys involved to calculate a secret key. The other party performs the same calculation with the same key agreement keys resulting in a shared secret key. In step 707, this key is then used for communication between processor 101 and the other party. In the preferred embodiment of the present invention all key agreement keys involved above are capable of having information embedded within the keys.

While the invention has been particularly shown and described with reference to a particular embodiment, it will be understood by those skilled in the art that various changes in form and details may be made therein without departing from the spirit and scope of the invention. For example, although the above description was given with a public key comprising information embedded within it, one of ordinary skill in the art will recognize that other cryptographic keys may have information embedded within them as well. For example, a secret AES key or a public DSS (Digitial Signature Standard) or Diffie-Hellman key may have embedded information. Additionally although the above description was given with information embedded within the least significant modulus bits, one of ordinary skill in the art will recognize that such information may be embedded anywhere within the modulus. It is intended that such changes come within the scope of the following claims.

1. A method for producing a cryptographic key, the method comprising the steps of:
determining information that is to be embedded within the cryptographic key; and
embedding the information within the cryptographic key.

2. The method of claim 1 wherein the step of determining the information comprises the step of determining information taken from the group consisting of an internet address, a physical address, a company name, a specification of the key holder's authority, words, wording, and a date.

3. The method of claim 1 further comprising the steps of:
determining a first prime number having a predetermined pattern;
determining a second prime number having the information embedded within the second prime number; and
wherein the step of embedding the information within the cryptographic key comprises the step of producing the cryptographic key based on the first and the second prime numbers.

4. The method of claim 3 wherein the first prime number has as its lower order bytes N−1 bytes of 0x00followed by a 0x01 byte.

5. The method of claim 4 wherein the second prime number comprises N bytes of the information.

6. A method for retrieving information about a cryptographic key, the method comprising the steps of:
determining that information needs to be retrieved from the cryptographic key;
determining a number (N) of bytes of information existing within the cryptographic key; and
analyzing the N bytes of the cryptographic key to determine the information.

7. The method of claim 6 wherein the step of determining that information needs to be retrieved from the cryptographic key comprises the step of determining that information needs to be retrieved from a cryptographic key comprising a product of two prime numbers.

8. A method for decrypting/verifying data, the method comprising the steps of:
receiving encrypted/signed information;
determining a cryptographic key; and
utilizing the cryptographic key for decrypting/verifying the encrypted/signed information, wherein the cryptographic key contains information embedded within the cryptographic key.

9. The method of claim 8 wherein the step of utilizing the cryptographic key comprises the step of utilizing the cryptographic key for decrypting/verifying the encrypted/signed information, wherein the cryptographic key contains wording embedded within the cryptographic key.

10. A method for encrypting/signing information, the method comprising the steps of:
accessing information;
determining a cryptographic key, wherein the cryptographic key comprises information embedded within the cryptographic key; and
encrypting/signing the information with an encryption/signature algorithm that utilizes the cryptographic key.

11. The method of claim 10 wherein the step of determining the cryptographic key comprises the step of determining a cryptographic key having wording embedded within the cryptographic key.

12. A cryptographic key comprising:
information embedded within the cryptographic key.

13. The cryptographic key of claim 12 wherein the information comprises information taken from the group consisting of an internet address, a physical address, a company name, a specification of the key holder's authority, words, and a date.

14. The cryptographic key of claim 12 wherein the cryptographic key comprises a product of a first and a second prime numbers.

15. The cryptographic key of claim 14 wherein the first prime number ends with N−1 bytes of 0x00followed by a 0x01 byte.

16. The cryptographic key of claim 15 wherein the second prime number ends with the information.

17. An apparatus comprising:
means for determining information that is to be embedded within the cryptographic key; and
means for embedding the information within the cryptographic key.

18. An apparatus comprising:
means for determining that information needs to be retrieved from a cryptographic key;
means for determining a number (N) of bytes of information existing within the cryptographic key; and
means for analyzing the N bytes of the cryptographic key to determine the information.

19. An apparatus comprising:
means for receiving encrypted/signed information;
means for determining a cryptographic key; and
means for utilizing the cryptographic key for decrypting/verifying the encrypted information, wherein the cryptographic key contains information embedded within the cryptographic key.

20. An apparatus comprising:
means for accessing information;
means for determining a cryptographic key, wherein the cryptographic key comprises information embedded within the cryptographic key; and
means for encrypting/signing the information with an encryption/signature algorithm that utilizes the cryptographic key.

21. A method for agreeing on a key for communication with another party, the method comprising the steps of:
receiving cryptographic key agreement key from another party;
determining a local cryptographic key; and
utilizing the cryptographic keys for key agreement, wherein either or both of the cryptographic keys contains embedded information.

22. The method of claim 21 wherein the step of utilizing the cryptographic key comprises the step of utilizing the cryptographic key for key agreement, wherein the cryptographic key contains wording embedded within the cryptographic key.

23. An apparatus comprising:
means for receiving a cryptographic key agreement key from a remote party;
means for determining a local cryptographic key; and
means for utilizing the cryptographic keys for agreeing on a key to use in communication, wherein the remote or local cryptographic keys or both of them contain embedded information.

24. An apparatus comprising:
means for accessing information;
means for determining a cryptographic key, wherein the cryptographic key comprises information embedded within the cryptographic key; and
means for agreeing on a key with a remote party through a key agreement algorithm that utilizes the cryptographic key.
